(19) United States
(12) Patent Application Publication
(10) Pub. No.: US 2010/0316101 A1
(43) Pub. Date: Dec. 16, 2010

(54) CROSS CONNECT BLOCK

(75) Inventors: Tam Kai Sau, Singapore (SG); Bryce Nicholls, New South Wales (AU); Kevin James Truskett, New South Wales (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/682,733

(22) PCT Filed: Jul. 3, 2008
(86) PCT No.: PCT/AU08/00980

§ 371 Date: Aug. 6, 2010

(30) Foreign Application Priority Data
Oct. 12, 2007 (SG) 200716924-6

(51) Int. Cl. H04B 1/38; H01R 4/24; H01R 13/648; H01R 43/00

(52) U.S. Cl. 375/222; 439/404; 29/825

(57) ABSTRACT

A cross connect block for a telecommunications system, including a plurality of insulation displacement contact slots arranged in two rows along a first side of the block; another plurality of insulation displacement contact slots arranged in two rows along a second side of the block; and a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block, wherein contacts arranged in one of said rows of the first side of the block are electrically isolated from corresponding contacts arranged in another of said rows of the first side of the block.

### TECHNICAL FIELD OF THE INVENTION

The present invention relates to a cross connect block.

### BACKGROUND OF THE INVENTION

Digital subscriber line (DSL) technology allows for high-bandwidth networking connections to be made over ordinary copper telephone lines. Traditional phone service typically relies on unshielded twisted pair (UTP) copper lines to connect homes and small businesses to the communications network operated by the telephone company (TELCO). Every one of these networks includes a central office (CO) that services a defined region, with each CO responsible for connecting and routing calls directed to sites that reside both internal to and external of the network.

Branching out from the central office are numerous remote terminals (RT) located throughout the region being served by the CO, with each RT providing the phone service for the subscribers located within a specific area or neighbourhood. One of the primary components that make up a remote terminal is a pair gain system, also known as a derived carrier system, or digital loop carrier system. In simplest terms, the pair gain system provides the TELCO with the capability to carry multiple services over a lesser number of lines, for example, five conversations over one telephone line. The pair gain system also is responsible for generating the dial tone signal one hears when they first pick up a telephone handset, indicating that an active connection is present.

FIG. 1 depicts a typical telephone connection between a pair gain system 10 of a remote terminal 11 and a subscriber 30. As indicated in FIG. 1, the connection between the pair gain system 10 and subscriber 30 is not accomplished directly, but instead in two legs. The first connection 10a exists between the pair gain system 10 and a cross connect block 20, while the second connection 20a is made between the cross connect block 20 and the subscriber 30. As indicated by its name, the purpose of the cross connect block 20 is to allow easy matching and connecting of two or more connections to one another, thereby facilitating the addition or removal of phone services to or from the subscriber 30.

To further illustrate the use of a cross connect block 20, consider the following example involving a typical modern day residence. New homes are often pre-wired to handle multiple telephone lines, i.e. six lines, to allow for future expansion. In this situation, there would be six connections running between the subscriber's house 30 and the cross connect box 20. However, if the subscriber only has two active phone lines, then only two connections representing the active circuits would run from the pair gain system 10 to the cross connect box 20. Later, if the subscriber wishes to add a new telephone line for a fax machine, a technician would have to run a new connection between the pair gain system 10 and the cross connect block 20, matching the new connection at the cross connect block 20 to the appropriate connection already present that runs to subscriber's house 30.

Note that each of connections 10a and 20a, along with the connections discussed below, although drawn as single lines in the figures, actually represent a cable pair, such as, typical unshielded twisted pair copper lines. For the remainder of the application, the terms “connection” and “cable pair” should be considered interchangeable. In view of this, it should be further understood that terminals for receiving these connections, such as can be found on cross connect block 20, are comprised of two conductors, with each conductor receiving one cable of the cable pair.

FIG. 2 depicts the same connection as previously depicted in FIG. 1. However, unlike the previous depiction, FIG. 2 provides a more detailed illustration of cross connect block 20, which is illustrated as an insulation-displacement connection (IDC) block. 20 Unlike blocks that rely on screw-terminals or a wire wrapping technique to secure wires to the block, IDC blocks provide for a gas-tight connection without requiring the removal of insulation covering the wire. Connection is achieved once a wire is placed into an IDC block contact, and then punched down, typically via an insertion tool, pressing the wire against the contact to form the gas-tight connection. Due to ease of use and effectiveness, cross connect blocks utilizing IDC contacts have become the standard within the telecommunications industry.

As DSL technology is relatively new compared to typical telephonic communication involving analog signals, many of the remote terminals 11 that are part of a telephone company's network were not designed to allow easy incorporation of newer technology such as DSL. Accordingly, the telephone companies have had to develop ways to effectively provide DSL service to their subscribers utilizing the existing equipment on the network.

FIG. 3 depicts a typical approach to incorporating DSL service with a remote terminal 11. The dial tone signal generated by the pair gain system 10 of the remote terminal 11 is directed to a splitter 50 via connection 10a. Splitter 50 also receives a connection 40a from a DSL system 40. DSL system 40 includes the equipment necessary for processing and directing the data signals back and forth between subscriber 30 and a digital subscriber line access multiplexer (DSLAM) (not shown). The DSLAM, which is operated by a service provider, takes all of the subscriber's DSL connections and aggregates them onto a single, high-density connection to the Internet. For the current illustrative example involving the integration of DSL at a remote terminal 11, the DSL system may be physically mounted inside the cabinet housing the remote terminal 11, or placed in its own cabinet mounted onto or next to the remote terminal 11 depending on factors such as size limitations and ease of access.

The role of splitter 50 is to combine the lower frequency signal from the pair gain system 10 with the higher frequency DSL data signal in such a way that they don't interfere with one another. Similarly, splitter 50 must also be capable of separating the signal sent by the subscriber 30 back into its two constituent components and then direct them back to the appropriate system. In FIG. 3, splitter 50 is depicted as an independent component separate from DSL system 40. Alternatively, splitter 50 may be incorporated into DSL system 40.

The combined signal produced by splitter 50 is delivered to cross connect block 20 over connection 50a, where it is then directed to subscriber 30 over connection 20a. Subscribers 30 can then access the higher frequency DSL signal by means of a DSL modem connected between their computing device and the telephone line(s) running throughout their residence. At the same time, standard telephones continue to have access to the lower frequency analog signals also routed over the line(s).

To accomplish the arrangement illustrated in FIG. 3, a service technician is required to go onsite and perform wiring locally at the remote terminal 11 that is servicing the subscriber 30. In order to combine the signal coming from the pair gain system 10 with the DSL data signal, the pair gain system 10 that normally is directly wired to cross connect block 20 must now be rerouted so that it interfaces with splitter 50. At splitter 50, the signal from the pair gain system 10 is combined with the DSL data signal, which also runs through splitter 50. The combined dial tone and DSL signal must then be placed back into communication with subscriber 30, requiring a new connection between splitter 50 and cross connect block 20. Due to these re-wiring requirements, the telephone service of subscriber 30 is disrupted; preventing them from making or receiving any telephone calls. Further, the duration of this disruption can vary depending on the knowledge and skill of the service technician, along with the condition of the remote terminal 11.

If a DSL subscriber decides he or she no longer wants DSL service, the service technician must access the remote terminal 11 again and disrupt the connection 40a that provides communication between the DSL system 40 and splitter 50. The splitter 50 must also be removed from the system, once again disrupting the subscriber's telephone service. Additionally, during the process of reconnecting pair gain system 10 back to cross connect block 20, there is always the chance that a mistake could be made, resulting in an improper connection to exist. This can lead to subscriber 30 going without telephone service for an extended duration until the problem can be corrected.

As time progresses, the need to include more transmission lines in already confined spaces within a frame or cabinet also typically increases. It is generally desirable to increase the density of connector modules, for example, in frames and cabinets to support the ever increasing demand. It is also generally desirable to maintain transmission performance when the density is increased.

It is generally desirable to overcome or ameliorate one or more of the above mentioned difficulties, or at least provide a useful alternative.

### SUMMARY OF THE INVENTION

In accordance with one aspect of the invention, there is provided a cross connect block for a telecommunications system, including:
(a) a plurality of insulation displacement contact slots arranged in two rows along a first side of the block;
(b) another plurality of insulation displacement contact slots arranged in two rows along a second side of the block; and
(c) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block,
   wherein contacts arranged in one of said rows of the first side of the block are electrically isolated from corresponding contacts arranged in another of said rows of the first side of the block.

Preferably, the cross connect block includes a plurality of apertures extending into the first side of the block between opposed pairs of slots and a plurality of apertures extending into the second side of the block between opposed pairs of slots.

Preferably, the apertures of the first side of the block are shaped to receive electrically conductive devices for electrically connecting opposed contacts and the apertures of the second side of the block are shaped to receive electrically conductive devices for electrically connecting opposed contacts.

Preferably, the cross connect block includes a plurality of electrically conductive shields arranged between adjacent pairs of contacts.

Preferably, the shields are electrically coupled together.

Preferably, each shield of said shields approximates the shape of one of said contacts so as to inhibit electromagnetic interference between adjacent pairs of contacts.

Preferably, each shield of said shields extends between opposed contacts so as to inhibit electromagnetic interference between adjacent pairs of contacts.

Preferably, the shields are electrically coupled you a common electrically conductive bar.

Preferably, the electrically conductive bar is electrically couplable to an electrically conductive bracket for mounting the block to a support structure.

In accordance with another aspect of the invention, there is provided, a cross connect block for a telecommunications system, including:
(a) a plurality of insulation displacement contact slots arranged in two rows along a first side of the block;
(b) another plurality of insulation displacement contact slots arranged in two rows along a second side of the block; and
(c) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block.

Preferably, the contacts arranged in one of said rows of the first side of the block are electrically isolated from corresponding contacts arranged in another of said rows of the first side of the block.

Preferably, the contacts arranged in one of said rows of the first side of the block are electrically coupled to corresponding contacts arranged in another of said rows of the first side of the block by spring finger contacts.

In accordance with another aspect of the invention there is provided, a method of delivering a digital subscriber line service to a subscriber, including the steps of:
(a) electrically connecting a first end of a first connection to an insulation displacement contact of a first contact of the above described cross connect block, where another insulation displacement contact of said first contact is electrically connected to a pair gain system;
(b) electrically connecting a second end of the first connection to an input of a splitter, said splitter selectively receiving a digital subscriber line signal;
(c) electrically connecting a first end of a second connection to an insulation displacement contact of a corresponding contact of the cross connect block, where another insulation displacement contact of said corresponding contact is electrically connected to the subscriber;
(d) electrically connecting a second end of the second connection to an output of the splitter;
(e) disrupting a signal path running through the block between the first contact and the corresponding contact so as to cause a signal from the pair gain system to be diverted through the first connection.

Preferably, the step of disrupting includes the step of removing a device effecting electric communication between the first contact and the corresponding contact.

In accordance with another aspect of the invention, there is provided a system for delivering digital subscriber line (DSL) service to a subscriber, comprising:
(a) a pair gain system for generating a pair gain signal;
(b) the above described cross connect block for selectively receiving one or more connections;
(c) a splitter for combining and separating signals, wherein one of said signals is a DSL signal from a DSL system;
(d) a first route for communicating said pair gain signal from said pair gain system, through said cross connect block, to said subscriber, and vice versa;
(e) a second route, partially overlapping said first route, for communicating said pair gain signal from said pair gain system, through said splitter, to said subscriber, and vice versa; and
(f) a disruptor for selectively activating one of said first and second routes.

Preferably, said first route comprises:
(i) a first connection between said pair gain system and a first terminal on said cross connect block, and
(ii) a second connection between a second terminal on said cross connect block and said subscriber; and
   wherein said second route comprises:
   (i) said first connection between said pair gain system and said first terminal on said cross connect block,
   (ii) a third connection between a third terminal on said cross connect block and said splitter, the third terminal being in electrical communication with the first terminal,
   (iii) a fourth connection between said splitter and a fourth terminal on said cross connect block, the fourth terminal being in electrical communication with the second terminal,
   (iv) said second connection between the second terminal on the cross connect block and the subscriber.

### BRIEF DESCRIPTION OF THE DRAWINGS

Preferred embodiments of the present invention are hereafter described, by way of non-limiting example only, with reference to the accompanying drawing in which:

FIG. 1 is a schematic diagram showing an a known system for distributing telephonic communication services to a subscriber;

FIG. 2 is another schematic diagram of the system shown in FIG. 1 showing the cross connect block in further detail;

FIG. 3 is a schematic diagram showing an a known system for distributing telephonic communication services along with digital subscriber line data service to a subscriber;

FIG. 4 is a schematic diagram showing an a system for distributing telephonic communication services along with digital subscriber line data service to a subscriber in accordance with a preferred embodiment of the invention;

FIG. 5 is a diagrammatic illustration of a perspective view of a cross connect block of the system shown in FIG. 4;

FIG. 6 is a diagrammatic illustration of an exploded view of the cross connect block shown in FIG. 5;

FIG. 7 is a diagrammatic illustration of cross-section view of the cross connect block shown in FIG. 5 taken through the line X-X;

FIG. 8 is a diagrammatic illustration of insulation displacement contacts of the cross connect block shown in FIG. 5;

FIG. 9 is a diagrammatic illustration of a front view of the cross connect block shown in FIG. 5;

FIG. 10 is a diagrammatic illustration of a side view of the cross connect block shown in FIG. 5 coupled to unshielded twisted pairs;

FIG. 11 is a diagrammatic illustration of another side view of the cross connect block shown in FIG. 5 coupled to unshielded twisted pairs;

FIG. 12 is a diagrammatic illustration of a top view of the cross connect block shown in FIG. 5 coupled to a plurality of insulated wires and front and back cable mount restraints;

FIG. 13 is a diagrammatic illustration of a back view of the cross connect block shown in FIG. 12;

FIG. 14 is a diagrammatic illustration of a front view of the cross connect block shown in FIG. 12;

FIG. 15 is a diagrammatic illustration of a side view of the cross connect block shown in FIG. 12;

FIG. 16 is a diagrammatic illustration of a another side view of the cross connect block shown in FIG. 12;

FIG. 17 is a diagrammatic illustration of an exploded view of the cross connect block shown in FIG. 12;

FIG. 18 is a diagrammatic illustration of a perspective exploded view of the cross connect block shown in FIG. 12;

FIG. 19 is a diagrammatic illustration of a cross-section view of the block shown in FIG. 14 taken through the line Y-Y;

FIG. 20 is a diagrammatic illustration of a front perspective view of another cross connect block;

FIG. 21 is a diagrammatic illustration of an exploded view of the cross connect block shown in FIG. 20;

FIG. 22 is a diagrammatic illustration of a perspective view of a shielding system of the cross connect block shown in FIG. 20;

FIG. 23 is a diagrammatic illustration of a front view of a back part of the cross connect block shown in FIG. 20; and

FIG. 24 is a diagrammatic illustration of a perspective view of the back part of the housing shown in FIG. 23.

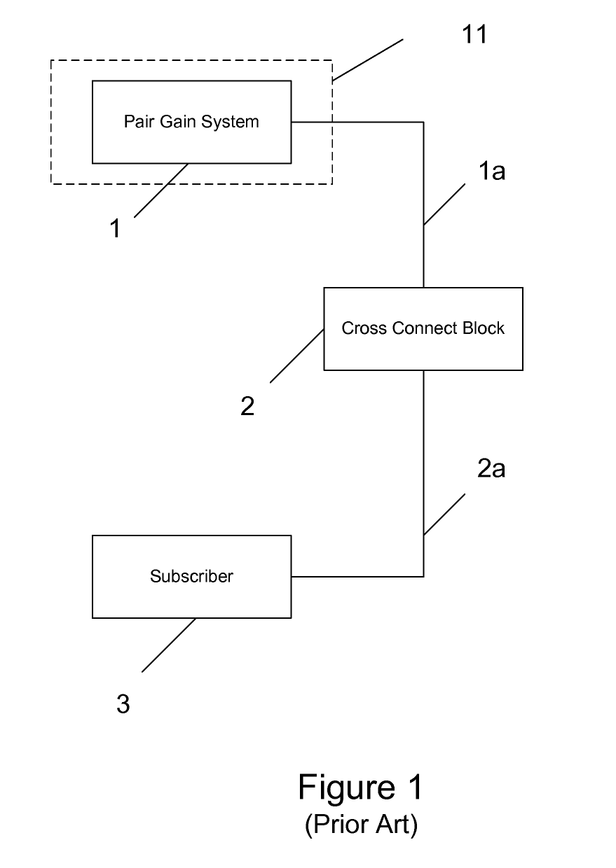

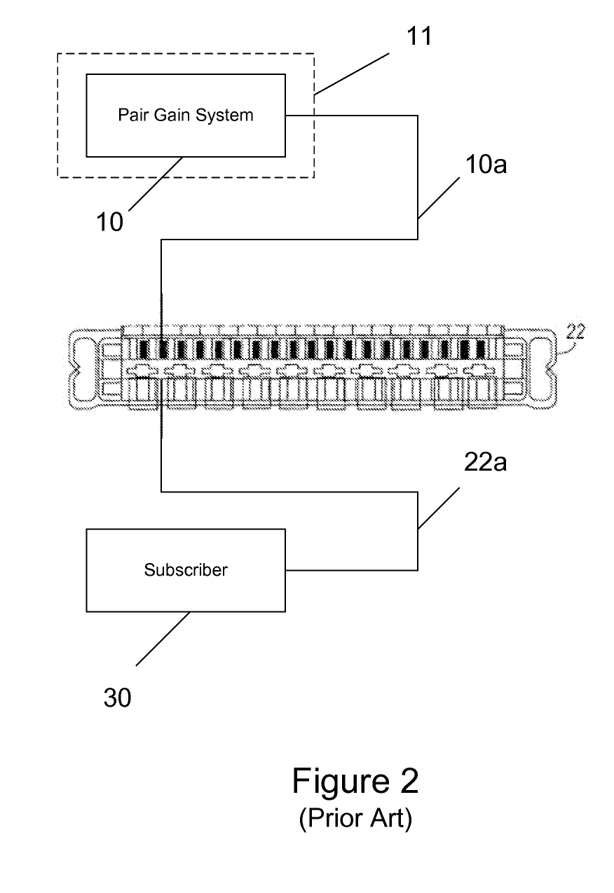

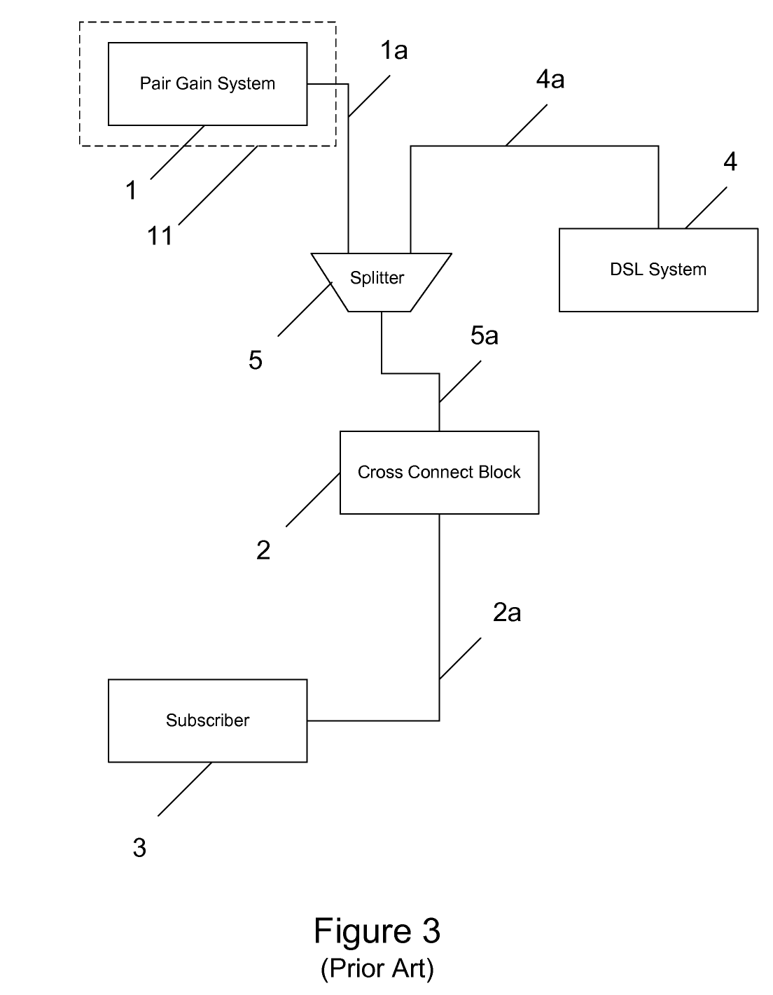

### DETAILED DESCRIPTION OF PREFERRED EMBODIMENTS OF THE INVENTION

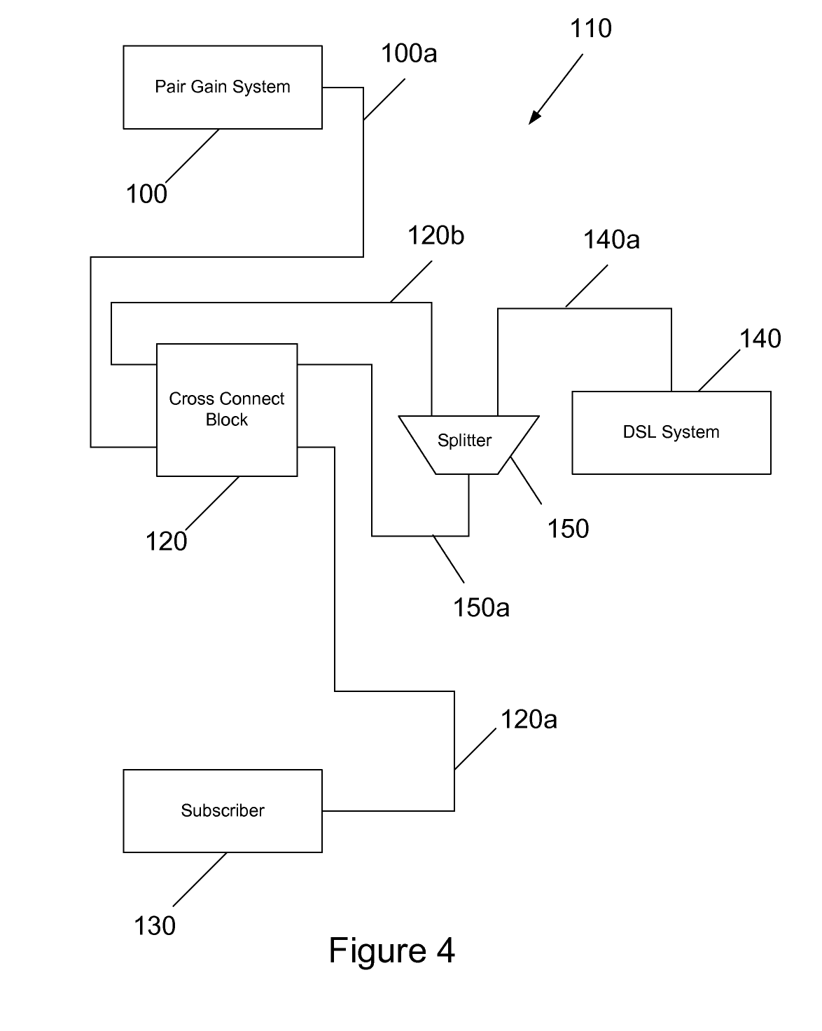

The pair gain system 100 of FIG. 4 connects to cross connect block 120 by connection 100a, while the cross connect block 120 connects to the subscriber 130 by connection 120a. Through these two connections, the subscriber 130 is provided with telephone service.

In order to provide a DSL service to subscriber 130, a service technician accesses the cross connect block 120 that serves the subscriber 130 and reroutes the telephone signal of subscriber 130 so as to combine it with a DSL signal. However, unlike prior methods of accomplishing this, according to the present embodiment the technician maintains connections 100a and 120a, thereby allowing phone service to subscriber 130 to continue during the installation of the DSL service.

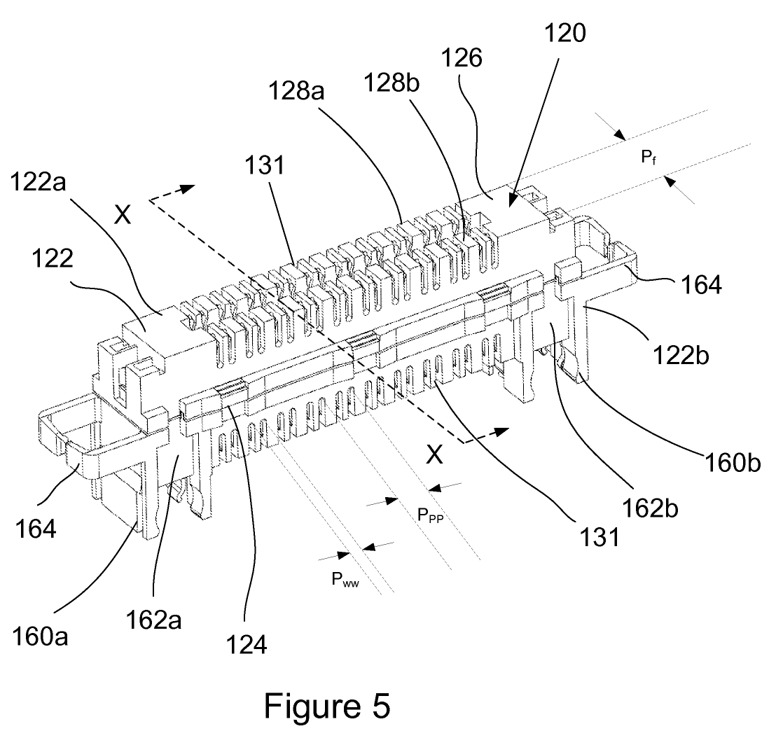

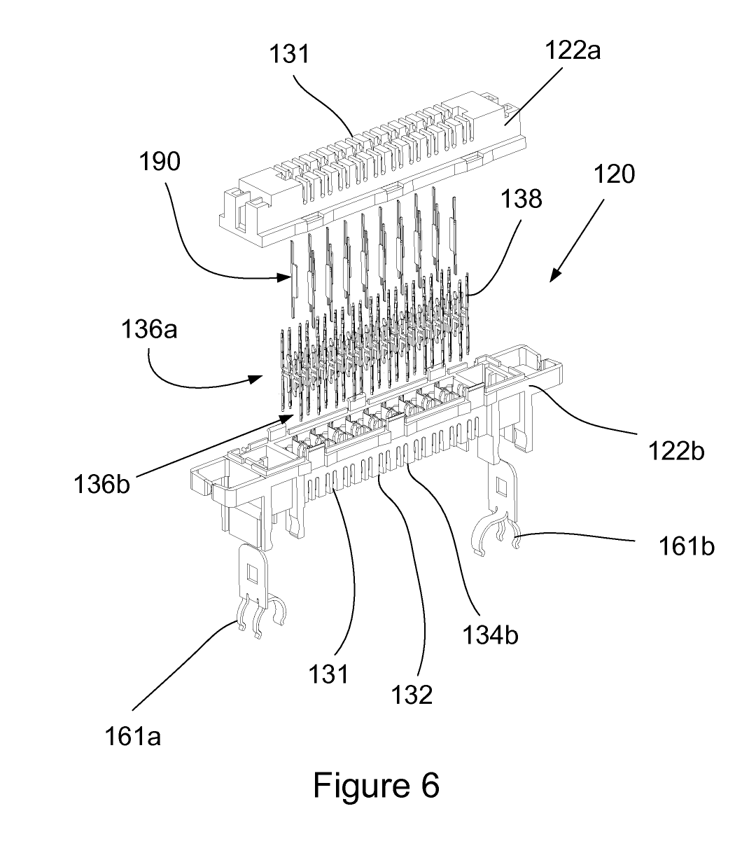

The cross connect block 120 is an insulation displacement contact (IDC) cross connect block. As particularly shown in FIGS. 5 and 6, the block 120 includes a housing 122 formed in front and back parts 122a, 122b coupled together by corresponding male and female parts of clips 124. A front side 126 of the front part 122a of the housing 122 includes two parallel rows 128a, 128b of insulation displacement contact slots 131. Each row 128a, 128b includes ten pairs of slots 131, where each slot 131 is shaped to receive a terminal end section of wire of an unshielded twisted pair. Similarly, a back side 127 of the back part 122b of the housing 122 includes two parallel rows 134a, 134b of insulation displacement contact slots 131. Each row 134a, 134b includes ten pairs of slots 131, where each slot 131 is shaped to receive a terminal end section of wire of an unshielded twisted pair.

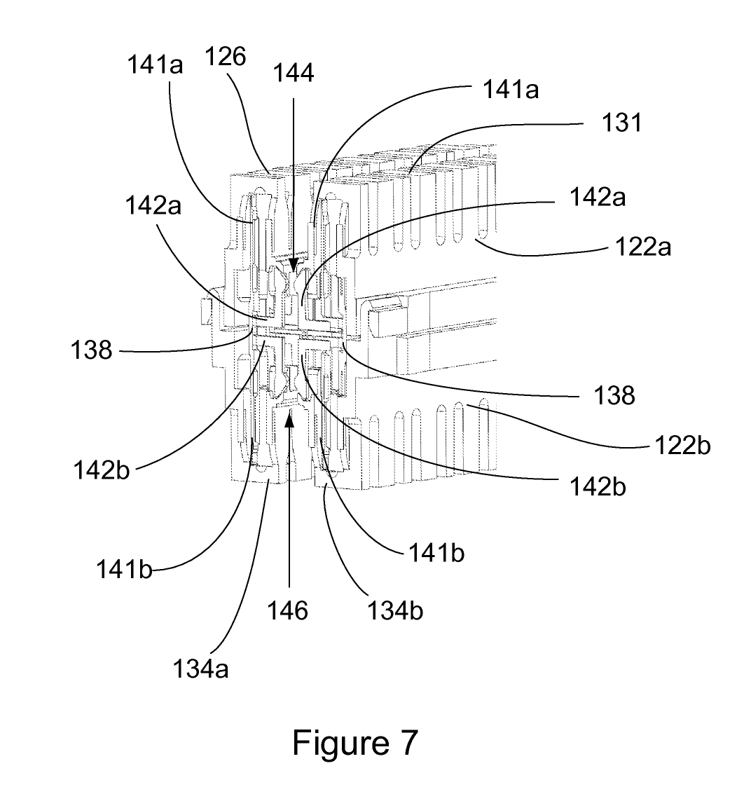

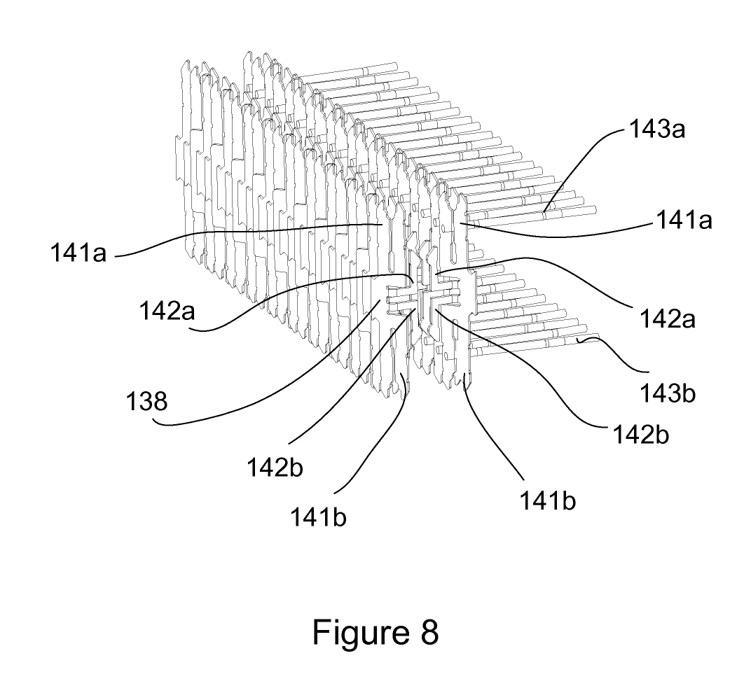

As particularly shown in FIGS. 7 and 8, the block 120 includes two rows 136a, 136b of contacts 138 each extending between the front and back parts 122a, 122b of the housing 122. Each contact 138 includes a front insulation displacement contact 141a seated in an insulation displacement contact slot 131 of the front part 122a of the housing 122 that is in electric communication with a back insulation displacement contact 141b seated in an insulation displacement contact slot 131 of the back 122b part of the housing 122. The arrangement is such that an insulated conductor 143a seated in an insulation displacement contact slot 131 located on the front part 122a of the housing 122 can be electrically connected to another insulated conductor 143b seated in a corresponding insulation displacement contact slot 131 located on the back part 122b of the housing 122 by a contact 138 extending therebetween.

Each contact 138 includes a pair of front and back contact arms 142a, 142b that firstly extend, in parallel, away from a central section of the contact 138 in the direction of a corresponding contact 138 located in an opposite row of the housing 122. The contact arms 142a, 142b then, at a central location in the housing 122, extend in opposite directions, at least partially towards respective front and back sides 126, 127 of the block 120. The pairs of contact arms 142a, 142b of opposed contacts 138a, 138b are electrically isolated from each other.

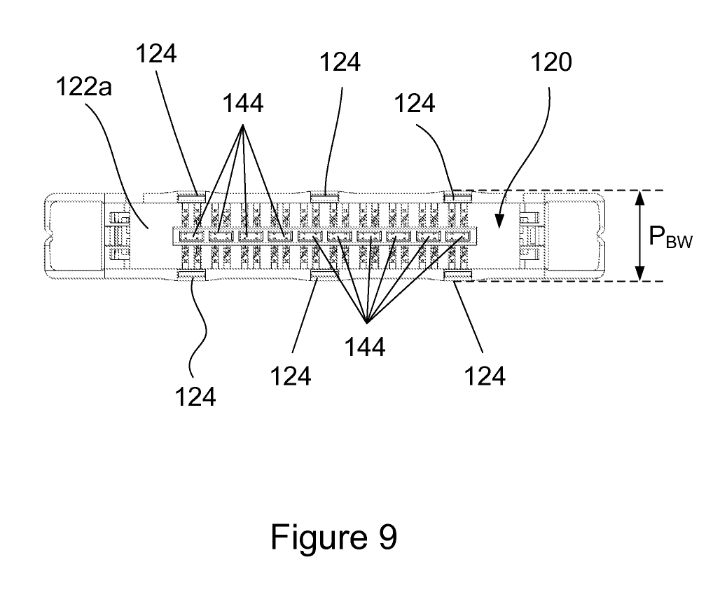

As shown in FIG. 9, the front side 126 of the housing 122 includes a series of apertures 144 extending through the front part 122a of the housing 122 exposing the front contact arms 142a of opposed contacts 138a, 138b. As such, a technician can form an electrical connection between opposed contacts 138a, 138b by inserting an electrically conductive device there between through a corresponding aperture 144. Similarly, the back side 127 of the housing 122 includes a series of apertures 146 extending through the back part 122b of the housing 122 exposing the back contact arms 142b of opposed contacts 138a, 138b. As such, a technician can form an electrical connection between opposed contacts 138a, 138b by inserting an electrically conductive device there between through a corresponding aperture 146.

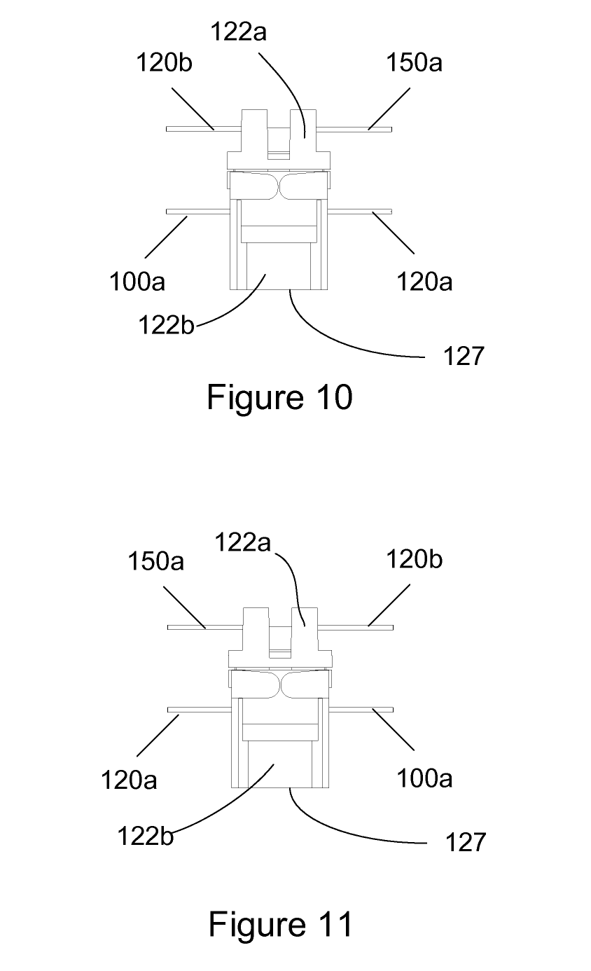

With reference to FIGS. 10 and 11, the existing connection 100a between the pair gain system 100 and the block 120 is effected by pressing the insulated conductors of the twisted pair into corresponding insulation displacement contact slots 131 of the back part 122b of the housing 122. Electric connections are thereby formed between the insulated conductors and the back insulation displacement contacts 141b. Similarly, the existing connection 120a between the connector block 120 and the subscriber 130 is effected by pressing the insulated conductors of the twisted pair into corresponding insulation displacement contact slots 131 located in an opposite row of the back part 122b of the housing 122. Electric connections are thereby formed between the insulated conductors and the back insulation displacement contacts 141b. An electrically conductive device (not shown) is inserted into the aperture 146 in the housing 122 to effect electric communications between the pair gain system 100 and the subscriber 130.

As particularly shown in FIG. 5, the block 120 includes the following dimensions:
a. Pair to Pair (P_{PP}) 7.4 mm;
b. Wire to Wire (P_{WW}) 3.0 mm;
c. Front Face (P_{F}) 16.5 mm; and
d. Block Width (P_{BW}) 22.3 mm.

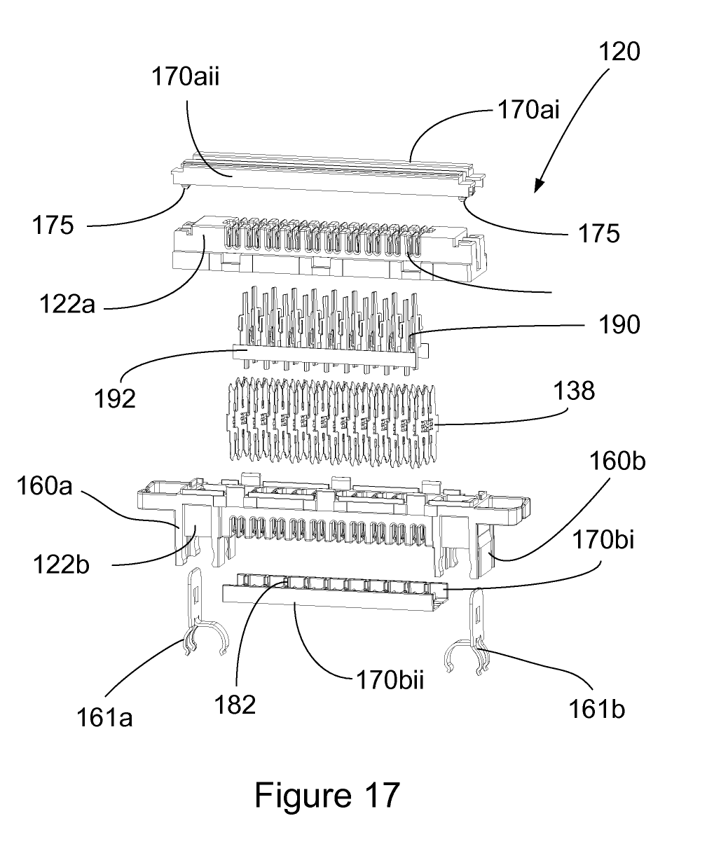

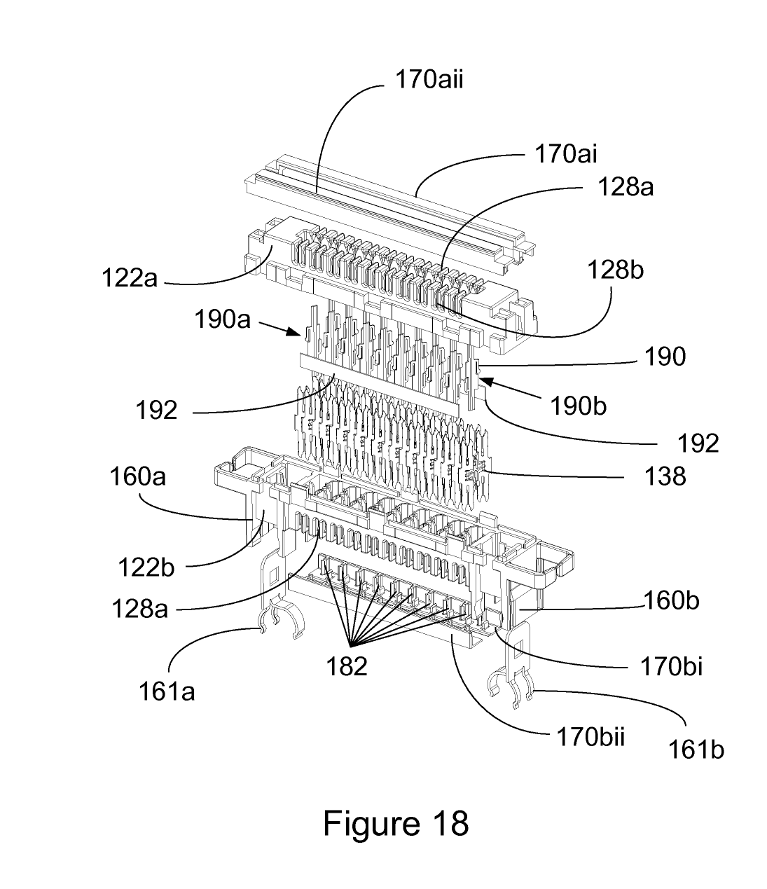

The block 120 includes clasps 160a, 160b for coupling to the rails of a Profil™ mounting system (not shown). As particularly shown in FIGS. 17 and 18, the clasps 160a, 160b include electrically conductive metal brackets 161a, 161b shaped to receive and releasably couple the block 120 a rail of a Profil™ mounting system. Clasps 160a, 160b are known in the art and are not described here in further detail. Left and right ends 162a, 162b of the back part 122b of the housing 122 include apertures (not shown) shaped to receive attachment lugs a back mount frame (not shown).

The block 120 includes jumper ring wire guides 164 for cable management.

To establish the system 110 for delivering digital subscriber line service to the subscriber 130, the service technician performs the following steps:
1. Electrically connect each wire of the twisted pair 120b to a contact 138 electrically connected to a corresponding wire of the twisted pair 100a. This is effected by pressing each wire of the pair 120b into a corresponding insulation displacement contact slot 131 on the front 122a part of the housing 122.
2. Electrically connect each wire of the twisted pair 150a to a contact 138 electrically connected to a corresponding wire of the twisted pair 120a. This is effected by pressing each wire of the pair 150a into a corresponding insulation displacement contact slot 131 on the front 122a part of the housing 122.

By performing the above-described steps, the technician effectively adds DSL system 140 and splitter 150 in parallel to the IDC block 120. To then activate DSL service to the subscriber 130, the technician removes the above mentioned electrically conductive device from the aperture 146. Upon its removal, the signal is rerouted to splitter 150 thereby activating DSL service to subscriber 130 without providing any noticeable disruption in telephone service.

If subscriber 130 desires to deactivate his or her DSL service, the service technician simply repeats the above-described process in reverse. Specifically, the electrically conductive device is inserted back into the aperture 146 of the block 120. With device reinserted, the signal path through the block 120 is once again established and the signal from pair gain system 100 takes the direct path consisting of connections 100a and 120a, instead of being redirected through splitter 150. Connections 120b and 150a can then be removed safely. As during the DSL installation stage, subscriber 130 notices no disruption in their telephone service while the DSL service is being uninstalled.

In the system 110, the block 120 obviates the need to effect double terminations in insulation displacement contacts 138. Electric connections between insulated conductors and the contacts 138 are advantageously more reliable. Furthermore, connections can be added and removed without effecting the integrity of an existing connections.

Additionally, unlike prior DSL installation methods, according to the current embodiment, connection 100a between the pair gain system 100 and IDC connect block 120 and connection 120a between IDC connect block 120 and subscriber 130 is never disrupted or removed. As a result, there is reduced chance of a misappropriate connection being made by the technician upon removal of DSL service, thereby significantly reducing the chances that a subscriber will have to go without telephone service due to technician error.

The DSL delivery system 110 and method described in the above embodiments is also advantageous as it provides the technician a good opportunity to check the condition of the subscriber's line. For example, just prior to disrupting the signal path through the cross connect block 120 by removal of the electrically conductive device from the aperture 146, the technician can instead insert a test cord in its place. This then allows the technician to “look both ways” along the line to detect signs of possible problems that could affect either telephone or DSL service.

In the above description, the method and system 110 for delivering DSL is described, for illustrative purposes, in relation to a remote terminal servicing a specific area or neighbourhood of subscribers. However, the new system and method is not limited to integrating signals at or near a remote terminal, but can also be used at various other locations within the network. For example, the system 110 and method could be advantageously used in a controlled environment vault utilized by TELCOs to house underground remote terminals and other networking equipment. Alternatively, the invention as presented in the embodiments above may also be beneficially used at a central office of the TELCO.

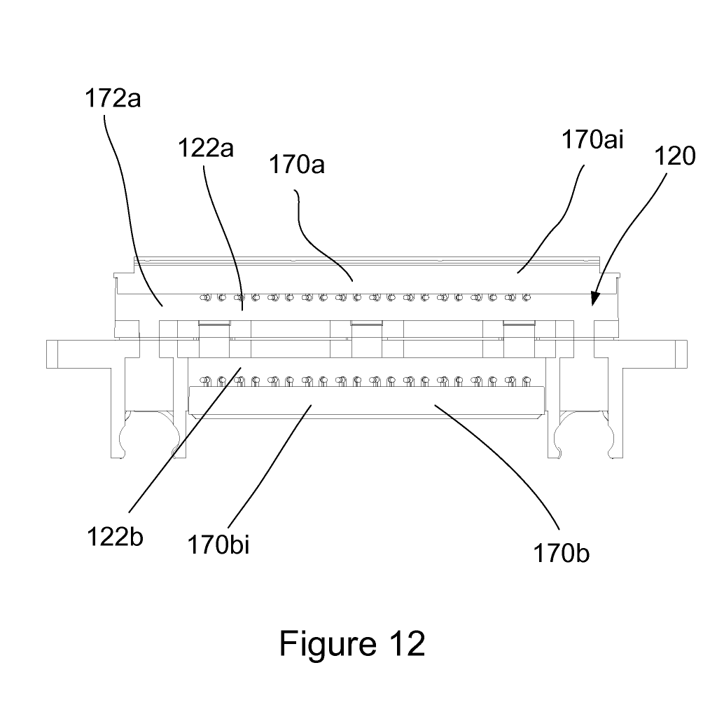

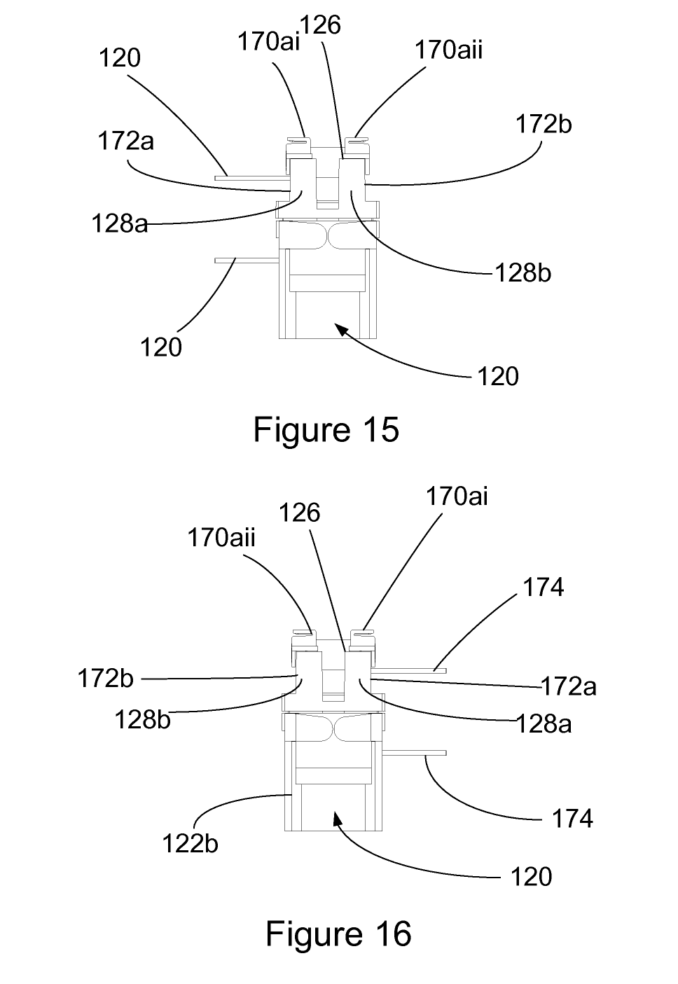

The connector block 120 shown in FIGS. 12 to 16 includes front and back cable mount restraint devices 170a, 170b. The front cable restraint device 170a is formed in top and bottom parts 170ai, 170aii that are each shaped to be fitted over a row 128a, 128b of insulation displacement contact slots 131. As particularly shown in FIGS. 15 and 16, the top and bottom parts 170ai, 170aii are fitted over the front side 126 of the insulation displacement contact slots 131. The top part 170ai is also shaped to fit over the top side 172a of the insulation displacement contact slots 131. Similarly, the bottom part 170aii is shaped to fit over the bottom side 172b of the insulation displacement contact slots 131. When so arranged, the top and bottom parts 170ai, 170aii of the front cable mount restraint device 170a inhibit removal of insulated conductors 174 that coupled to the contacts 138 seated in insulation displacement contact slots 131. As particularly shown in FIG. 17, the top and bottom parts 170ai, 170aii of the front restraint device 170a include lugs 175 shaped for insertion into corresponding apertures 176 of the front side 126 of the housing 122. The lugs 175 include a locking surface (not shown) shaped to engage respective apertures 176 to thereby secure the top and bottom parts 170ai, 170aii in fixed positions.

Alternatively, the top and bottom sides 172a, 172b of the top and bottom parts 170ai, 170aii of the front cable restraint device 170a are identification label holders.

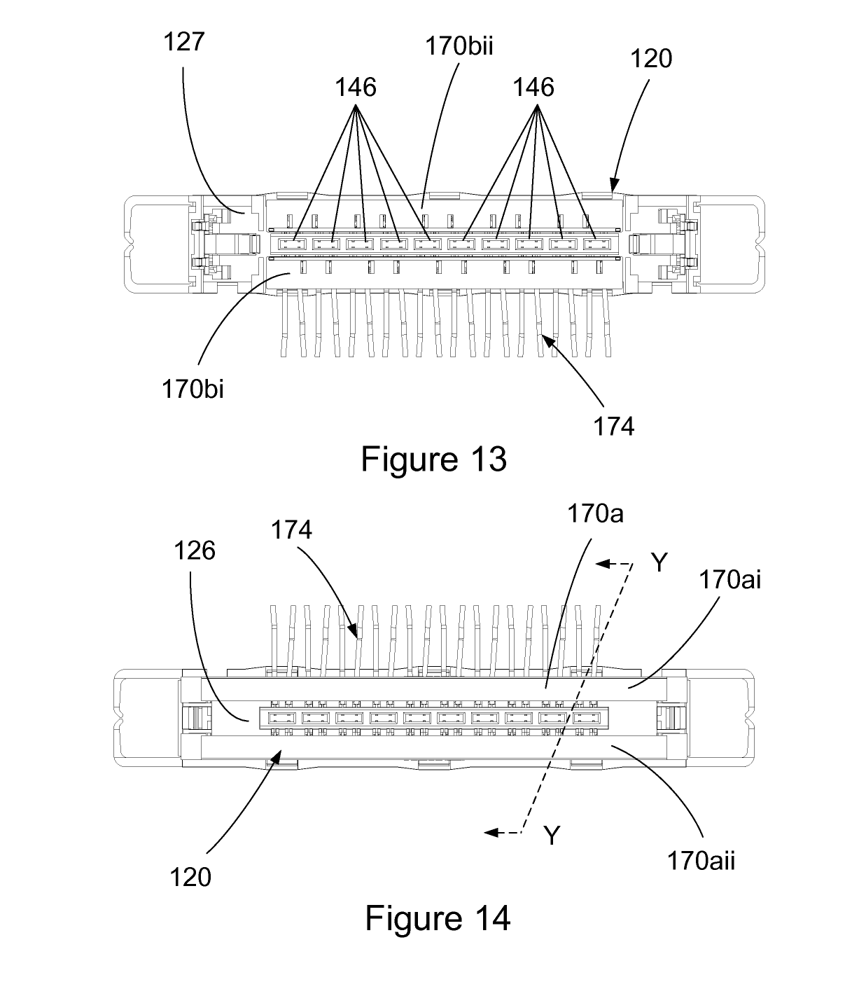

The back cable restraint device 170b is formed in top and bottom parts 170bi, 170bii that are each shaped to be fitted over a row 128a, 128b of insulation displacement contact slots 131. As particularly shown in FIGS. 13, 17 and 18, the top and bottom parts 170bi, 170bii are fitted over the back side 127 of the insulation displacement contact slots 131. The top part 170bi is also shaped to fit over the top side 172a of the insulation displacement contact slots 131. Similarly, the bottom part 170bii is shaped to fit over the bottom side 172b of the insulation displacement contact slots 131. As particularly shown in FIG. 18, the top and bottom parts 170bi, 170bii of the back restraint device 170b include a plurality of lugs 182 shaped for insertion into corresponding apertures of insulation displacement contact slots 131 of the back part 122b of the housing 122. The lugs 182 resiliently bear against the wall defining the slots 131 and thereby hold the parts 170bi and 170bii in fixed positions. When so arranged, the top and bottom parts 170bi, 170bii of the back cable mount restraint device 170b inhibit removal of insulated conductors 174 that coupled to the contacts 138 seated in insulation displacement contact slots 131.

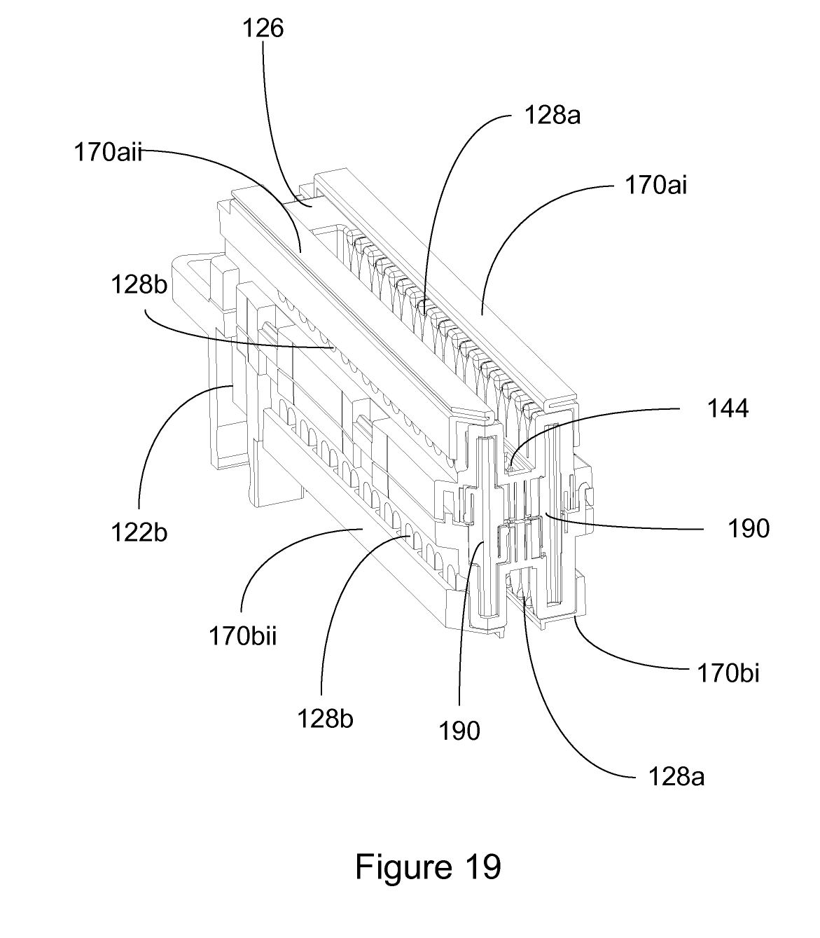

In order to improve the transmission performance, the block 120 includes two rows 190a, 190b of electrically conductive transmission shields 190, where the shields 190 of each row 190a, 190b are arranged between adjacent pairs of contacts 138 in the manner shown in FIGS. 17 to 19. When so arranged, the contacts 138 of each row 136a, 136b are shielded from electromagnetic radiation from two aspects. The shields 190 are shaped to extend between the front and back insulation displacement contacts 141a, 141b of the contacts 138. The shields 190 of each row 190a, 910b are electrically connected to each other by the electrically conductive bar 192. The shields 190 advantageously improve the transmission performance of the block 120 so that it confirms to Category 5e.

Advantageously, each insulation displacement contact 141a, 141b of the block 120 is arranged such that a side to side direction of the bifurcated contact arms is substantially 45 degrees to the direction of extend of an insulated conductor that is pressed into the contact 141a, 141b.

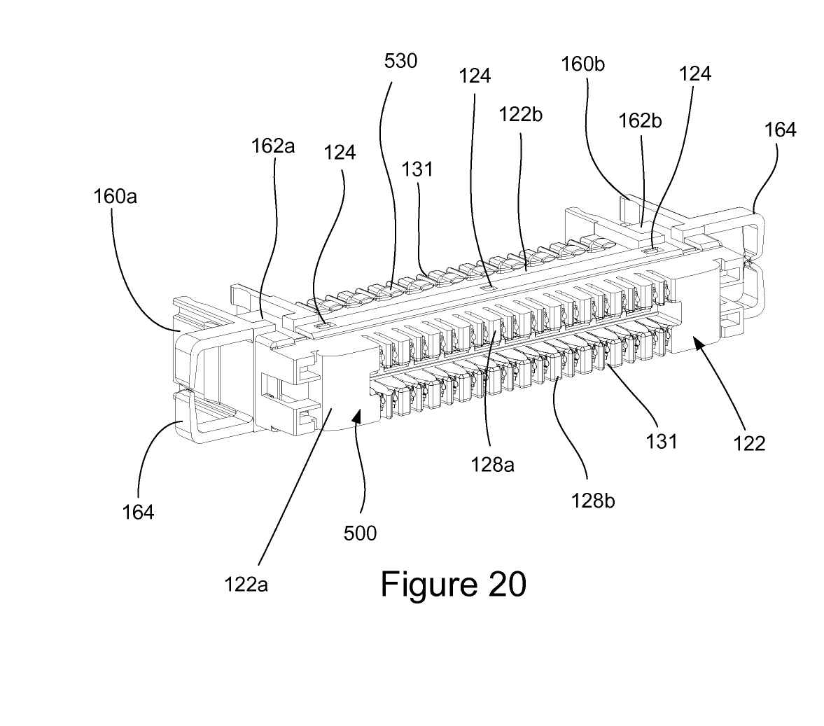

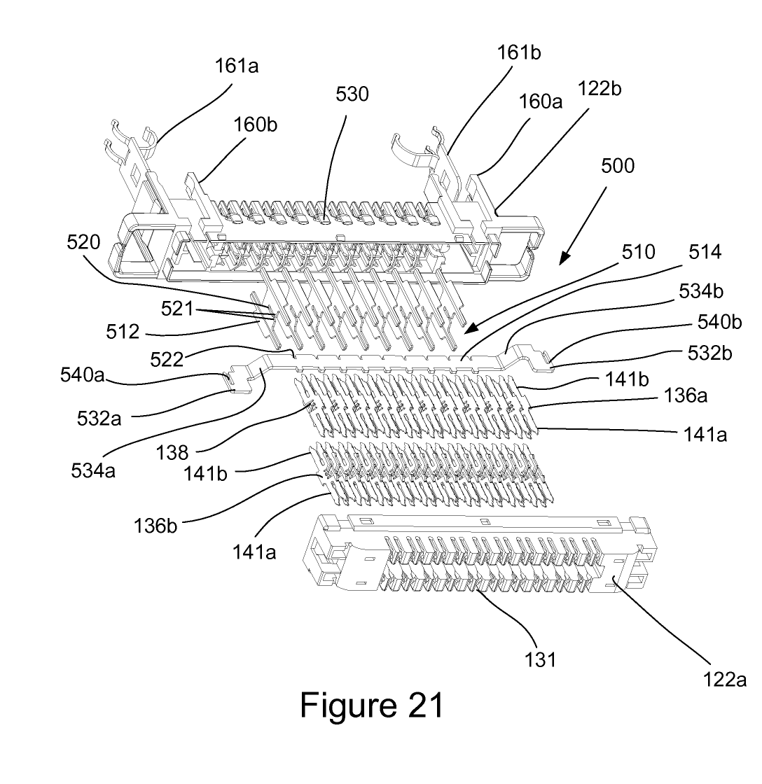

The cross connect block 500 shown in FIGS. 20 and 21 operates in an analogous manner to that of the cross connect block 120 and like parts are referenced with like numbers. A description of the operation of these common parts is not repeated below. However, is to be understood that they perform the same, or similar, function. The cross connect block 500 is suitable for use in the system 110 for delivering digital subscriber line service to a subscriber.

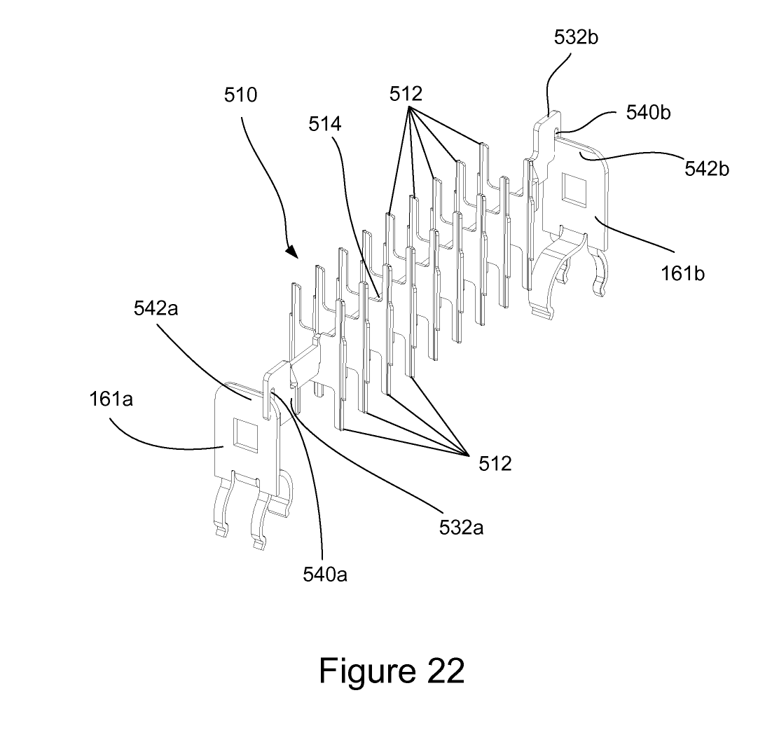

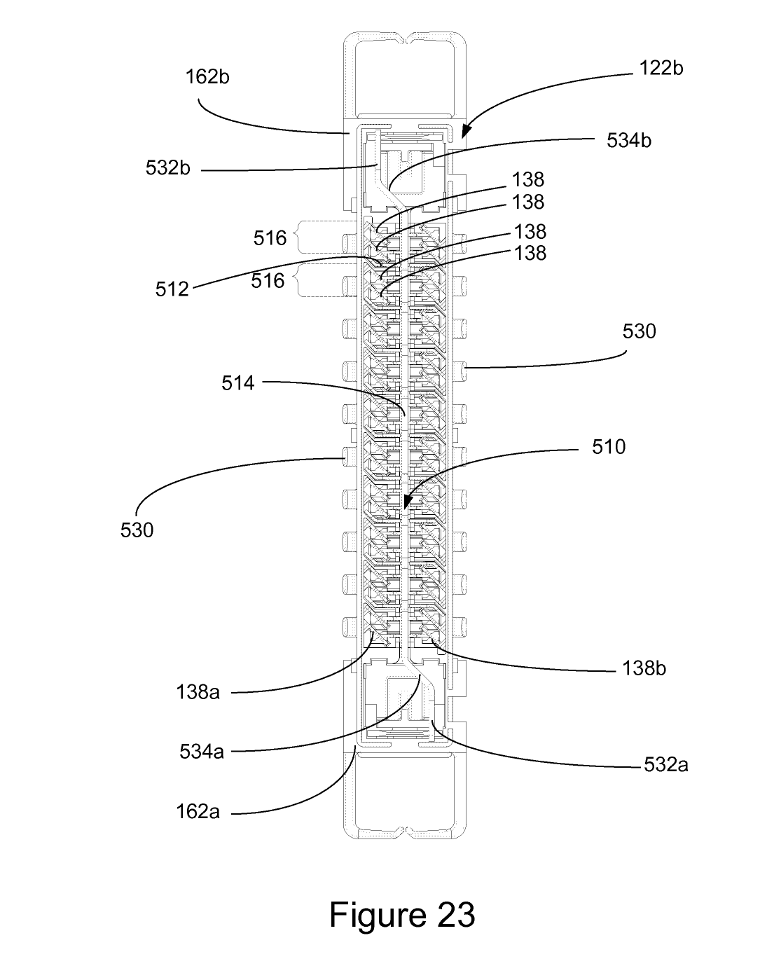

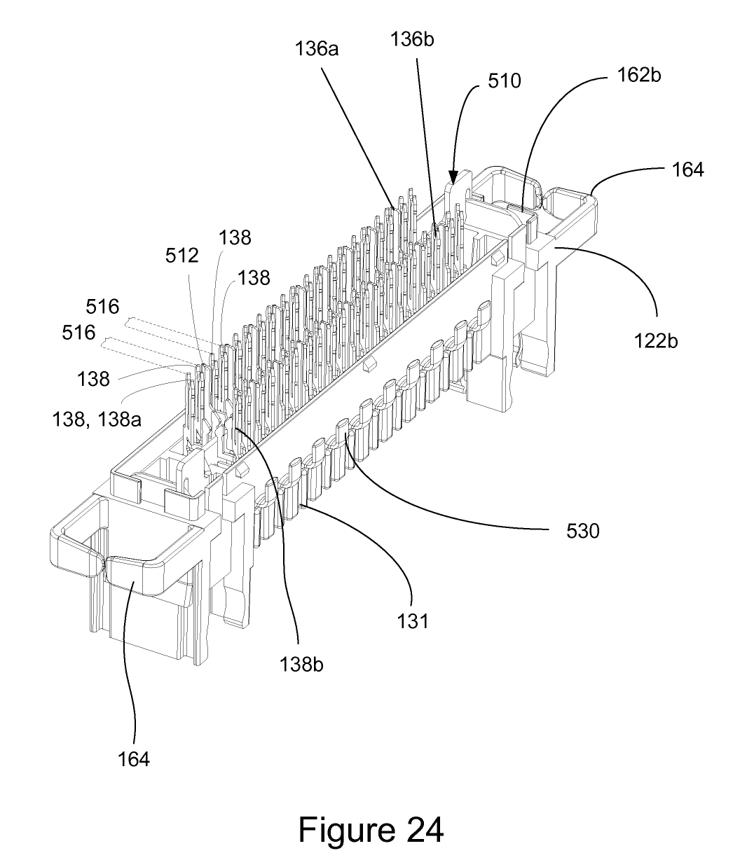

As an alternative to the above-described shields 190 of the cross connect block 120, the cross connect block 500 includes a shielding system 510 that acts to improve transmission performance of the block 500 up to Cat 5e or above. As particularly shown in FIG. 22, the shielding system 510 includes a single row of electrically conductive shields 512 electrically coupled to an electrically conductive transmission bar 514. The shields 512 are spaced apart along the extent of the bar 514 so as to be located between adjacent pairs 516 of contacts 138 in FIGS. 23 and 24. When so arranged, the opposed contacts 138a, 138b of each row 136a, 136b are shielded from electromagnetic radiation from two aspects.

The front and back insulation displacement contacts 141a, 141b and the front and back contact arms 142a, 142b of an opposed pair of contacts 138a, 138b are generally “H” shaped. The shields 512 have a corresponding “H” shape so as to be interposed between electrically conductive surfaces of adjacent pairs 516 of contacts 138. The shields 512 thereby inhibit electromagnetic radiation between adjacent pairs 516 of contacts 138.

As particularly shown in FIG. 21, the cross-member 518 of each “H” shaped shield 512 includes a “U” shaper slot 520 shaped to mate with a corresponding “U” shaped slot 522 on the transmission bar 514. The open end of each slot 520 includes two opposed bosses 521 that partially close the slot. The bosses 521 are arranged to resiliently bear against the transmission bar 514 and secure the shields 512 thereto. The shields 512 are in electrical communication when coupled to the transmission bar 514 in the described manner.

The back part 122b of the housing 122 is shaped to receive the transmission bar 514 so that it extends centrally between the left and right ends 162a, 162b of the housing 122. As particularly shown in FIG. 24, the transmission bar 514 is seated at the front side of the back part 122b of the housing 122 and extends along an isolation gap formed between electrically isolated front and back contact arms 142a, 142b of opposed contacts 138a, 138b.

As particularly shown in FIG. 22, opposite ends 532a, 532b of the transmission bar 514 extend in parallel with the left to right direction of extent of the block 500 and are joined to the body of the transmission bar 514 by transverse members 534a, 534b. The opposite ends 532a, 532b of the transmission bar 514 are thereby offset from the centre of the back part 122b of the housing 122 and extend along top and bottom sides 536, 538 of the block 500 respectively.

The opposite ends 532a, 532b ends of the transmission bar 514 include slots 540a, 540b that are shaped to receive, and form an electrical connection with, upper ends 542a, 542 of electrically conductive brackets 161a, 161b inserted into clasps 160a, 160b. The open end of each slot 540a, 540b includes two opposed bosses that partially close the slot 540a, 540b. The bosses are arranged to resiliently bear against the upper ends of the brackets 161a, 161b and secure the transmission bar 514 thereto.

In doing so, the shielding system 510 for the block 500 is coupled to the rails of the Profil™ mounting system and thereby integrated with earthing of the surge protector.

Alternatively, the slots 540a, 540b are shaped to receive, and form an electrical connection with, upper surfaces of electrically conductive ends of a back mount frame (not shown). Once again, in doing so, the shielding system 510 for the block 500 is coupled to the back mounting system and is thereby integrated with earthing of the surge protector.

The shielding system 510 advantageously improve the transmission performance of the block 120 so that it conforms to Category 5e or above.

The cross connect block 500 also includes a plurality of strain relief bosses 530 arranged in series along the top and bottom sides 536, 538 of the back part 122b of the 122. The bosses 530 work with the jumper ring wire guides 164 to inhibit insulated conductors coupled to insulation displacement contacts from being unintentionally pulled out. For example, in use, a plurality of twisted pairs are arranged to extend upwardly through the jumper ring wire guides 164 and then transversely across to respective ones of bosses 530. the twisted pairs are wrapped around the bosses and bent towards respective insulation displacement contact slots 131 for termination to contacts 138. The bosses 530 reduce forces applied to the twisted pairs extending through the jumper ring wire guide 164 from being transferred to the terminal ends of the wires.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### LIST OF PARTS

Pair gain system 100
System 110
Cross connect block 120, 500
Subscriber 130
Connection/twisted pair 100a, 120a, 120b, 140a, 150a
Housing 122
Front part of housing 122a
Back part of housing 122b
Front side 126
Back side 127
Row of IDC slots 128a, 128b, 134a, 134b,
IDC slot 131
Row of contacts 136a, 136b
Contact 138
Opposed contacts 138a, 138b
DSL system 140
Front IDC 141a
Back IDC 141b
Front contact arm 142a
Back contact arm 142b
Insulated conductor 143a, 143b
Aperture 144, 146, 176
Splitter 150
Clasp 160a, 160b
Bracket 161a, 161b
Left end of housing 162a
Right end of housing 162b
Jumper ring wire guide 164
Cable mount restraint device 170a, 170b
Top and bottom parts 170ai, 170aii, 170bi, 170bii
Top side of IDC slots 172a
Bottom side of IDC slots 172b
Lug 175, 182
Shield 190, 512
Row of shields 190a, 190b
Electrically conductive bar 192
Shielding system 510
Transmission bar 514
Contact pair 516
Cross-member of shield 518
Slot 520, 522, 540a, 540b
Boss 521
Strain relief boss 530
End of transmission bar 532a, 532b
Transverse member 534a, 534b
Top side of block 536
Bottom side of block 538
Upper end of bracket 542a, 542b

1. A cross connect block for a telecommunications system, comprising:
(a) a plurality of insulation displacement contact slots arranged in two rows along a first side of the block;
(b) another plurality of insulation displacement contact slots arranged in two rows along a second side of the block; and
(c) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block,
wherein contacts arranged in one of said rows of the first side of the block are electrically isolated from corresponding contacts arranged in another of said rows of the first side of the block.

2. The cross connect block claimed in claim 1, including a plurality of apertures extending into the first side of the block between opposed pairs of slots and a plurality of apertures extending into the second side of the block between opposed pairs of slots.

3. The cross connect block claimed in claim 2, wherein the apertures of the first side of the block are shaped to receive electrically conductive devices for electrically connecting opposed contacts and the apertures of the second side of the block are shaped to receive electrically conductive devices for electrically connecting opposed contacts.

4. The cross connect block claimed in claim 1, wherein the slots of each row of said rows along the first side of the block are arranged in pairs and the slots of each row of said rows along the second side of the block are arranged in pairs.

5. The cross connect block claimed in claim 4, wherein each row of said rows along the first side of the block includes 10 pairs of slots and each row of said rows along the second side of the block includes 10 pairs of slots.

6. The cross connect block claimed in claim 1, including a cable mount restrain member coupled to the each one of said rows of the first side of the block.

7. The cross connect block claimed in claim 1, including a cable mount restrain member coupled to the each one of said rows of the second side of the block.

8. The cross connect block claimed in claim 1, including a plurality of electrically conductive shields arranged between adjacent pairs of contacts.

9. The cross connect block claimed in claim 8, wherein the shields are electrically coupled together.

10. The cross connect block claimed in claim 8, wherein each shield of said shields approximates the shape of one of said contacts so as to inhibit electromagnetic interference between adjacent pairs of contacts.

11. The cross connect block claimed in claim 8, wherein each shield of said shields extends between opposed contacts so as to inhibit electromagnetic interference between adjacent pairs of contacts.

12. The cross connect block claimed in claim 8, wherein the shields are electrically coupled to a common electrically conductive bar.

13. The cross connect block claimed in claim 12, wherein the electrically conductive bar is electrically couplable to an electrically conductive bracket for mounting the block to a support structure.

14. The cross connect block claimed in claim 13, wherein the support structure is a Profil™ mounting system.

15. The cross connect block claimed in claim 13, wherein the support structure is a back mount system.

16. The cross-connect block claimed in claim 1, including a plurality of bosses for receiving insulated conductors of twisted pairs and routing the conductors towards respective ones of the insulation displacement contact slots.

17. A cross connect block for a telecommunications system, including:
(a) a plurality of insulation displacement contact slots arranged in two rows along a first side of the block;
(b) another plurality of insulation displacement contact slots arranged in two rows along a second side of the block; and
(c) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block.

18. The cross connect block claimed in claim 17, wherein contacts arranged in one of said rows of the first side of the block are electrically isolated from corresponding contacts arranged in another of said rows of the first side of the block.

19. The cross connect block claimed in claim 17, wherein contacts arranged in one of said rows of the first side of the block are electrically coupled to corresponding contacts arranged in another of said rows of the first side of the block by spring finger contacts.

20. A method of delivering a digital subscriber line service to a subscriber, comprising:
(a) providing a cross connect block for a telecommunications system, including:
(i) a plurality of insulation displacement contact slots arranged in two rows along a first side of the block;
(ii) another plurality of insulation displacement contact slots arranged in two rows along a second side of the block; and
(iii) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block, wherein contacts arranged in one of said rows of the first side of the block are electrically isolated from corresponding contacts arranged in another of said rows of the first side of the block;
b) electrically connecting a first end of a first connection to an insulation displacement contact of a first contact of the cross connect block, where another insulation displacement contact of said first contact is electrically connected to a pair gain system;
(c) electrically connecting a second end of the first connection to an input of a splitter, said splitter selectively receiving a digital subscriber line signal;
(d) electrically connecting a first end of a second connection to an insulation displacement contact of a corresponding contact of the cross connect block, where another insulation displacement contact of said corresponding contact is electrically connected to the subscriber;
(e) electrically connecting a second end of the second connection to an output of the splitter;
(f) disrupting a signal path running through the block between the first contact and the corresponding contact so as to cause a signal from the pair gain system to be diverted through the first connection.

21. The method claimed in claim 20, wherein the step of disrupting includes the step of removing a device effecting electric communication between the first contact and the corresponding contact.

22. A system for delivering digital subscriber line (DSL) service to a subscriber, comprising:
(a) a pair gain system for generating a pair gain signal;
(b) the cross connect block for selectively receiving one or more connections, the cross connect block including:
(i) a plurality of insulation displacement contact slots arranged in two rows along a first side of the block,
(ii) another plurality of insulation displacement contact slots arranged in two rows along a second side of the block: and
(iii) a plurality of contacts, each contact of said contacts including a first insulation displacement contact, arranged for engagement with an insulated conductor seated in one of said slots of the first side of the block, in electrical communication with a second insulation displacement contact, arranged for engagement with an insulated conductor seated in a corresponding one of said slots of the second side of the block, wherein contacts arranged in one of said rows of the first side of the block are electrically isolated from corresponding contacts arranged in another of said rows of the first side of the block;
(c) a splitter for combining and separating signals, wherein one of said signals is a DSL signal from a DSL system;
(d) a first route for communicating said pair gain signal from said pair gain system, through said cross connect block, to said subscriber, and vice versa;
(e) a second route, partially overlapping said first route, for communicating said pair gain signal from said pair gain system, through said splitter, to said subscriber, and vice versa; and
(f) a disruptor for selectively activating one of said first and second routes.

23. The system according to claim 22, wherein said first route comprises:
(i) a first connection between said pair gain system and a first terminal on said cross connect block, and
(ii) a second connection between a second terminal on said cross connect block and said subscriber; and
wherein said second route comprises:
(i) said first connection between said pair gain system and said first terminal on said cross connect block,
(ii) a third connection between a third terminal on said cross connect block and said splitter, the third terminal being in electrical communication with the first terminal,
(iii) a fourth connection between said splitter and a fourth terminal on said cross connect block, the fourth terminal being in electrical communication with the second terminal,
(iv) said second connection between the second terminal on the cross connect block and the subscriber.

24. The system according to claim 22, wherein said disruptor disrupts said first route so as to divert said pair gain signal to said splitter.

25. The system according to claim 24, wherein said disruptor disrupts a signal path running through said cross connect block between said first terminal and said second terminal.

26. The system according to claim 25, wherein said disruption of said signal path includes a removal of a device that effects electrical communication between the first terminal and the second terminal.

27. The system according to claim 26, wherein no noticeable disruption of telephone service occurs during said selective activation of said first and second routes.

28.-30. (canceled)
